(19) United States
(12) Patent Application Publication
(10) Pub. No.: US 2025/0260524 A1
(43) Pub. Date: Aug. 14, 2025

(54) SYSTEMS AND METHODS FOR CALIBRATION OF RECEIVE CHAINS IN A MIMO WIRELESS COMMUNICATION DEVICE

(71) Applicant: HFCL Limited, Bangalore (IN)

(72) Inventors: Parag AGGARWAL, Bangalore (IN); Subhas Chandra MONDAL, Bangalore (IN)

(21) Appl. No.: 19/048,601

(22) Filed: Feb. 7, 2025

(30) Foreign Application Priority Data
Feb. 10, 2024 (IN) IN202441009075

(51) Int. Cl. H04L 5/00; H04W 56/00

(52) U.S. Cl. CPC H04L 5/0023; H04W 56/0035

(57) ABSTRACT

Systems and methods for antenna calibration of receive chains in a multiple-input-multiple-output (MIMO) wireless communication device are described. In particular, the method includes determining, by a controller (234) associated with the MIMO wireless communication device, that user data transmission is initiated in an operating phase of the MIMO wireless communication device. A need for calibration of a plurality of receive chains in the MIMO wireless communication device is determined. In response to the determination, the method includes determining an arrival of at least one of: a second last guard period of a special time slot in a Time-Division Duplex (TDD) radio frame, or an Orthogonal Frequency-Division Multiplexing (OFDM) symbol allocated by one or more higher layers in a Frequency-Division Duplex (FDD) radio frame. The method includes performing fine-tuned calibration of each of the plurality of receive chains.

### CROSS REFERENCE TO RELATED APPLICATION(S)

This application is related to and claims priority to Indian Patent Application No. IN 202441009075 filed on Feb. 10, 2024, the contents of which are incorporated by reference herein.

### TECHNICAL FIELD

The present disclosure, in general, relates to managing calibration of radio frequency (RF) components in a wireless communication network, and in particular, relates to systems and methods for calibration of receive chains in a multiple-input-multiple-output (MIMO) wireless communication device, for example, a base station.

### BACKGROUND

The fifth-generation (5G) new radio (NR) base station (BS) supports high peak data rates with better reliability to multiple users simultaneously in a larger coverage area. The key enabler for such support is massive multiple-input-multiple-output (MIMO) technology. It provides several techniques to boost the performance of the BS, such as spatial diversity to enhance transmission robustness, spatial multiplexing to improve the peak data rates, and beamforming to increase signal-to-noise ratio (SNR). To get full advantages of MIMO techniques, the radio paths should have identical characteristics, such as having same gain and phase responses with same group delay. However, the actual radio paths have different characteristics due to different components and radio frequency (RF) paths. The characteristics of the radio path may also be affected by temperature variations during actual data transmission. Thus, calibration of the radio paths is required to ensure consistent MIMO performance.

For antenna calibration, usually time-frequency resources are reserved by higher layers and user data transmission on the reserved resources is halted during the calibration process. This reduces spectrum efficiency of the BS, especially when the calibration is set to repeat periodically. Hence, there is a need for a system and a method to maintain high spectrum efficiency without disturbing the user data transmission during the calibration. During an operating phase or data transmission, the BS may implement the antenna calibration from time to time to check an integrity of estimated calibration coefficients. This repetition may be referred to as calibration periodicity. Generally, the calibration is set to repeat after regular intervals, referred to as periodic calibration. The periodic calibration with lower periodicity may increase the processing overhead of a system, while higher periodicity may reduce effectiveness of the calibration process.

FIGS. 1A-1C illustrate system architecture for antenna calibration.

FIG. 1A depicts an ideal scenario where all receive chains have similar characteristics. FIG. 1B depicts a base station with no calibration logic. FIG. 1C depicts the base station with an internal antenna calibration block.

Antenna calibration requires a loopback mechanism, which may be over-the-air (OTA) or an internal dedicated feedback path. OTA calibration may require a receiver or a user equipment (UE) which may not be available during the calibration, especially in a start-up/bootup phase of the BS. While the calibration with the internal dedicated feedback path does not require a receiver or a UE, it requires additional resources whose functionalities again need to be optimized for enhanced performance.

The existing systems do not offer any efficient mechanism for antenna calibration of the 5G NR MIMO BS with low processing complexity while maintaining spectrum efficiency. Therefore, there is, a need for a system and a method to calibrate the RF paths at a start-up phase and during an operating phase of the 5G NR MIMO BS adaptively without impacting user data transmission.

### Objects of the Present Disclosure

It is an object of the present disclosure to provide a system and a method to calibrate Radio Frequency (RF) paths at a start-up phase and during an operating phase of a fifth-generation (5G) multiple-input-multiple-output (MIMO) wireless communication device adaptively without impacting user data transmission.

It is an object of the present disclosure to provide a system and a method to calibrate RF receive paths during run-time of a communication apparatus, i.e., calibration of RF receive path in between data transmission without affecting a data transmission rate.

It is an object of the present disclosure to provide a system and a method for handling variation in temperature and processing delay between multiple RF paths.

It is an object of the present disclosure to provide a system and a method to adaptively calibrate RF receive chains in a multiple-input-multiple-output (MIMO) communication apparatus which also utilizes resources optimally and effectively.

### SUMMARY

In an aspect, the present disclosure relates to a method for calibration of receive chains in a start phase of a multiple-input-multiple-output (MIMO) wireless communication device, including setting, by a controller associated with the MIMO wireless communication device, delay values to zero and calibration coefficients to unity with zero phase for each of a plurality of receive chains, sending, by the controller, orthogonal sequences on each of the plurality of receive chains, estimating, by the controller, a first response and a first time delay for each of the plurality of receive chains by cross-correlating each receive signal from each of the plurality of receive chains with an orthogonal sequence, performing, by the controller, Orthogonal Frequency-Division Multiplexing (OFDM) demodulation on the estimated first responses to obtain frequency domain first responses, and computing, by the controller, calibration coefficients and delay values for each of the plurality of receive chains based on the frequency domain first responses to mitigate relative gain and phase differences with respect to a given receive chain.

In an embodiment, the method may include sending, by the controller, the orthogonal sequences on each of the plurality of receive chains, controlling, by the controller, the first time delay in each of the plurality of receive chains by adjusting a timing of the orthogonal sequences, estimating, by the controller, a second response and a second time delay for each of the plurality of receive chains, performing, by the controller, the OFDM demodulation on the estimated second responses to obtain frequency domain second responses, and applying, by the controller, the computed calibration coefficients on the frequency domain second responses.

In an embodiment, the method may include computing, by the controller, a gain difference, a phase difference, and a timing delay difference of each of the plurality of receive chains with respect to the given receive chain, and comparing, by the controller, the gain difference, the phase difference, and the timing delay difference of each of the plurality of receive chains with a gain error threshold, a phase error threshold, and a delay error threshold, respectively.

In an embodiment, responsive to at least one of the gain difference, the phase difference, and the timing delay difference of each of the plurality of receive chains being less than the gain error threshold, the phase error threshold, and the delay error threshold, respectively, the method may include storing, by the controller, the computed calibration coefficients and the computed delay values in a database associated with the MIMO wireless communication device to perform calibration of the plurality of receive chains.

In an embodiment, responsive to at least one of the gain difference, the phase difference, and the timing delay difference of each of the plurality of receive chains being greater than the gain error threshold, the phase error threshold, and the delay error threshold, respectively, the method may include computing, by the controller, updated calibration coefficients and/or updated delay values for each of the plurality of receive chains based on the frequency domain first responses to mitigate the gain difference, the phase difference, or the timing delay difference with respect to the given receive chain.

In another aspect, the present disclosure relates to a method for calibration of receive chains in a MIMO wireless communication device, including determining, by a controller associated with the MIMO wireless communication device, that user data transmission is initiated in an operating phase of the MIMO wireless communication device, determining, by the controller, a need for calibration of a plurality of receive chains in the MIMO wireless communication device, in response to the determination, detecting, by the controller, an arrival of at least one of: a second last guard period of a special time slot in a TDD radio frame, or an OFDM symbol allocated by one or more higher layers in a FDD radio frame, and performing, by the controller, fine-tuned calibration of each of the plurality of receive chains based on the detection.

In an embodiment, determining, by the controller, the need for the calibration of the plurality of receive chains may be based on at least one of: an expiry of a timer, a request by the one or more higher layers, an event of a change in temperature, and a fault being identified in a given receive chain of the plurality of receive chains.

In an embodiment, performing, by the controller, the fine-tuned calibration of each of the plurality of receive chains may include sending, by the controller, orthogonal sequences on each of the plurality of receive chains, controlling, by the controller, a delay in each of the plurality of receive chains by adjusting a timing of the orthogonal sequences, estimating, by the controller, a response and a time delay for each of the plurality of receive chains by cross-correlating each receive signal from each of the plurality of receive chains with an orthogonal sequence, performing, by the controller, OFDM demodulation on the estimated responses to obtain frequency domain responses, and applying, by the controller, calibration coefficients on the frequency domain responses, wherein the calibration coefficients may be computed during a start phase of the MIMO wireless communication device or during earlier stages of the operating phase.

In an embodiment, the method may include computing, by the controller, a gain difference, a phase difference, and a timing delay difference of each of the plurality of receive chains with respect to a given receive chain, and comparing, by the controller, the gain difference, the phase difference, and the timing delay difference of each of the plurality of receive chains with a gain error threshold, a phase error threshold, and a delay error threshold, respectively.

In an embodiment, responsive to at least one of the gain difference, the phase difference, and the timing delay difference of each of the plurality of receive chains being less than the gain error threshold, the phase error threshold, and the delay error threshold, respectively, the method may include storing, by the controller, the calibration coefficients in a database associated with the MIMO wireless communication device to perform the fine-tuned calibration of each of the plurality of receive chains.

In an embodiment, responsive to at least one of the gain difference, the phase difference, and the timing delay difference of each of the plurality of receive chains being greater than the gain error threshold, the phase error threshold, and the delay error threshold, respectively, the method may include computing, by the controller, updated calibration coefficients for each of the plurality of receive chains based on the frequency domain responses, detecting, by the controller, an arrival of at least one of: a second last guard period of a consecutive special time slot in the TDD radio frame, or another OFDM symbol allocated by the one or more higher layers in the FDD radio frame, and performing, by the controller, the fine-tuned calibration of each of the plurality of receive chains based on the detection.

In an embodiment, the fine-tuned calibration may include at least an adaptive calibration, where for the adaptive calibration, the method may include adaptively controlling, by the controller, a value of the timer for performing the fine-tuned calibration of the plurality of receive chains.

In another aspect, the present disclosure relates to a MIMO wireless communication device for calibration of receive chains in a start phase, including a controller associated with a processor, and a memory operatively coupled to the processor, where the memory includes processor-executable instructions which, when executed by the processor, cause the controller to set delay values to zero and calibration coefficients to unity with zero phase for each of a plurality of receive chains, send orthogonal sequences on each of the plurality of receive chains, estimate a first response and a first time delay for each of the plurality of receive chains by cross-correlating each receive signal from each of the plurality of receive chains with an orthogonal sequence, perform OFDM demodulation on the estimated first responses to obtain frequency domain first responses, and compute calibration coefficients and delay values for each of the plurality of receive chains based on the frequency domain first responses to mitigate relative gain and phase differences with respect to a given receive chain.

In another aspect, the present disclosure relates to a MIMO wireless communication device for calibration of receive chains in an operating phase, including a controller associated with a processor, and a memory operatively coupled to the processor, where the memory includes processor-executable instructions which, when executed by the processor, cause the controller to determine that user data transmission is initiated in the operating phase of the MIMO wireless communication device, determine a need for calibration of a plurality of receive chains in the MIMO wireless communication device, in response to the determination, detect an arrival of at least one of: a second last guard period of a special time slot in a TDD radio frame, or an OFDM symbol allocated by one or more higher layers in a FDD radio frame, and perform fine-tuned calibration of each of the plurality of receive chains based on the detection.

In an embodiment, to perform the fine-tuned calibration of each of the plurality of receive chains, the memory may include processor-executable instructions which, when executed by the processor, may cause the controller to send orthogonal sequences on each of the plurality of receive chains, control a delay in each of the plurality of receive chains by adjusting a timing of the orthogonal sequences, estimate a response and a time delay for each of the plurality of receive chains by cross-correlating each receive signal from each of the plurality of receive chains with an orthogonal sequence, perform OFDM demodulation on the estimated responses to obtain frequency domain responses, and applying, by the controller, calibration coefficients on the frequency domain responses, wherein the calibration coefficients may be computed during a start phase of the MIMO wireless communication device or during earlier stages of the operating phase.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIGS. 1A and 1B illustrate conventional system architecture for antenna calibration in a 5^{th} Generation (5G) Multiple Input Multiple Output (MIMO) wireless communication device.

FIG. 1C illustrates a system architecture for antenna calibration with a calibration block.

FIG. 2 illustrates an exemplary system architecture for antenna calibration with a calibration port inside an antenna panel, in accordance with an embodiment of the present disclosure.

FIG. 3 illustrates an exemplary system architecture for antenna calibration with no calibration port inside an antenna panel, in accordance with an embodiment of the present disclosure.

FIG. 4A illustrates an exemplary representation of a 5G New Radio (NR) Time Division Duplex (TDD) radio frame, in accordance with an embodiment of the present disclosure.

FIG. 4B illustrates an exemplary representation for implementing calibration in a special slot with two and three guard periods, in accordance with an embodiment of the present disclosure.

FIG. 4C illustrates an exemplary representation for implementing calibration in a special slot with four guard periods, in accordance with an embodiment of the present disclosure.

FIG. 5 illustrates a high-level flow chart of an exemplary method for antenna calibration of receive chains, in accordance with an embodiment of the present disclosure.

FIG. 6 illustrates a flow chart of an exemplary method for coarse calibration of receive chains during a start-up phase of a MIMO wireless communication device, in accordance with an embodiment of the present disclosure.

FIG. 7 illustrates a flow chart of an exemplary method for implementing fine-tuned calibration of receive chains during an operating phase of a MIMO wireless communication device, in accordance with an embodiment of the present disclosure.

FIG. 8 illustrates an example gain plot of estimated value of receive chain responses before calibration.

FIG. 9 illustrates an exemplary representation of fine-tuned calibration in two special slots, in accordance with an embodiment of the present disclosure.

FIGS. 10A and 10B illustrate exemplary representations of a gain plot of a time domain signal of third receive chain and eighth receive chain without calibration, respectively.

FIGS. 11A and 11B illustrate exemplary representations of a gain plot of time domain signals of third receive chain and eighth receive chain with antenna calibration, in accordance with an embodiment of the present disclosure.

FIGS. 12A and 12B illustrate exemplary representations of a gain plot of frequency domain signals of third receive chain and eighth receive chain without antenna calibration.

FIGS. 13A and 13B illustrate exemplary representations of a gain plot of frequency domain signals of third receive chain and eighth receive chain with antenna calibration, in accordance with an embodiment of the present disclosure.

FIGS. 14A and 14B illustrate exemplary representations of a phase plot of frequency domain signals of third receive chain and eighth receive chain without antenna calibration.

FIGS. 15A and 15B illustrate exemplary representations of a phase plot of frequency domain signals of third receive chain and eighth receive chain with antenna calibration, in accordance with an embodiment of the present disclosure.

FIG. 16 illustrates an exemplary computer system in which or with which embodiments of the present disclosure may be implemented.

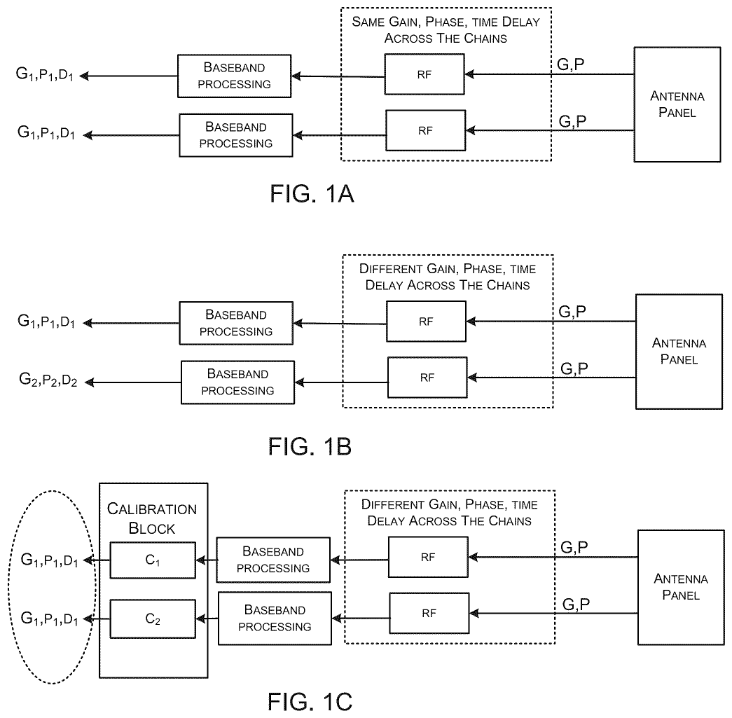

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

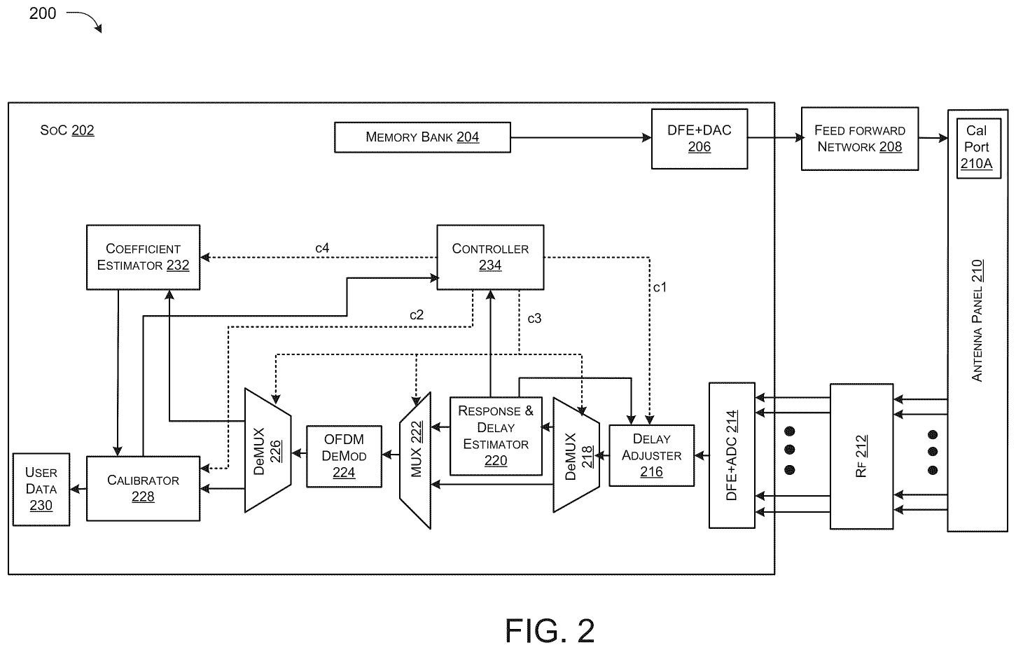

The various embodiments throughout the disclosure will be explained in more detail with reference to FIGS. 2-16.

FIG. 2 illustrates an exemplary system architecture (200) for antenna calibration with a calibration port (210a) inside an antenna panel (210), in accordance with an embodiment of the present disclosure.

In particular, the exemplary system architecture (200) may represent a communication system such as a 5^{th} Generation (5G) or next-generation communications system (200). As depicted, the architecture (200) includes an antenna panel (210) in which an in-built calibration port (210a) is provided. A signal may be injected into the calibration port (210a) and then equally distributed to all Radio Frequency (RF) antenna ports of the antenna panel (210). These signals may be further connected to receive chains of a multiple-input-multiple-output (MIMO) wireless communication device for calibration. Examples of the MIMO wireless communication device may include, without limitation, a base station, a Fixed Wireless Access Customer Premises Equipment (FWA CPE), small cells, routers, User Equipment (UE), and so on. The system architecture (200) may be utilized in both types of base stations, which have antenna panels (210) with and without in-built calibration ports (210a).

In an embodiment, the system architecture (200) may include a System on Chip (SoC) (202). The SoC (202) may include a processing system (or interchangeably referred to as a processor) and a programming logic for baseband processing of incoming data and other control functions.

In an embodiment, a memory bank (204) may include orthogonal sequences on a time domain (ZT) and their frequency domain equivalent (ZF) for calibration coefficients. In an example embodiment, the orthogonal sequences may include, but not limited to, ZadoffChu sequence (Z), constant amplitude zero auto-correlation waveform (CAZAC) signal, and Walsh-Hadamard code, etc.

In an embodiment, user data (204) may be in the form of a frequency domain modulated in-phase (I) and quadrature (Q) symbols from higher layers of, for example, the base station. The higher layers may be a high Physical (PHY) layer including, but not limited to, Media Access Control (MAC) and Radio Link Control (RLC) layers.

In an embodiment, a Digital Front End (DFE) and a digital to analog converter (DAC) (206) may pre-distort and upconvert the incoming time-domain IQ symbols and then convert them to an analog domain.

In an embodiment, a feedback network (208) may include a series of gain blocks to keep enough power level of a signal for calibration.

In an embodiment, the antenna panel (210) may receive radiated signals. As discussed herein, the antenna panel (210) may include the in-built calibration port (210a).

In an embodiment, RF module (212) may process the signal with a series of RF components. The RF module (212) may maintain the power level of the feedback signal in an operating range of an Analog to Digital Converter (ADC) (214).

In an embodiment, a DFE and ADC (214) may convert the analog signal to a digital signal and then down-convert the digital signal.

In an embodiment, a delay adjuster (216) may delay time domain data with estimated delay values to compensate for the timing differences with respect to a reference chain.

In an embodiment, a first demultiplexer (DeMUX) (218) may switch the time domain delayed data between a response and delay estimator (220) and a MUX (222).

In an embodiment, the response and delay estimator (220) may estimate the response and time delay of all receive chains.

In an embodiment, the MUX (222) may switch between user data (230) and estimated response of the receive chains. The user data (230) may be frequency domain modulated IQ symbols from a calibrator (228).

In an embodiment, an Orthogonal Frequency-Division Multiplexing (OFDM) demodulator (224) may perform cyclic prefix removal and Fast Fourier Transform (FFT) operations.

In an embodiment, a second demultiplexer (DeMUX) (226) may switch the signal between the calibrator (228) and a coefficient estimator (232).

In an embodiment, the calibrator (228) may contain complex multipliers to multiply the frequency domain data with calibration coefficients to compensate for gain, phase, and timing differences with respect to the reference chain.

In an embodiment, the coefficient estimator (232) may estimate the calibration coefficients for antenna calibration based on the estimated response and time delay of all receive chains.

In an embodiment, a controller (234) may control the whole operation of the antenna calibration. During a start-up phase, the controller (234) may initially identify control signals (c₁), (c₂) to reset the delay values and the calibration coefficients, respectively. The controller (234) may identify the control signal (c₁) to update the delay values with their estimated value during the rest of the start-up phase and operating phase. The controller (234) may identify the control signal (c₂) to update the coefficients with their estimated value during the rest of the start-up phase and operating phase. The controller (234) may also identify the control signal (c₃) to control the MUX (222), the first DeMUX (218), and the second DeMUX (226). They work in two modes, namely an antenna calibration mode and a user data transmission/reception mode. In the antenna calibration mode, the MUX (222), the first DeMUX (218), and the second DeMUX (226) are configured to connect the orthogonal sequences to the coefficient estimator (232). In the user data transmission/reception mode, the MUX (222), the first DeMUX (218), and the second DeMUX (226) are configured to connect the incoming user data to the calibrator (228).

The controller (234) may take an input from the calibrator (228) to calculate a gain difference (E_{g}) and a phase difference (Eₚ), and from the response and delay estimator (220) to calculate a timing delay difference (E_{d}) for each chain with respect to the reference chain. The controller (234) may compare the gain difference (E_{g}), the phase difference (Eₚ), and the timing delay difference (E_{d}) with a gain error threshold (T_{g}), a phase error threshold (Tₚ), and a delay error threshold (T_{d}), respectively. It may be appreciated that all thresholds may be configurable and may be defined as per the design implementation. If the estimation of coefficients is required based on the comparison, the controller (234) may identify a control signal (c₄) to inform the coefficient estimator (232) for the estimation of the calibration coefficients.

In an embodiment, during the operating phase, the controller (234) may control the periodicity of the calibration by updating a timer value adaptively.

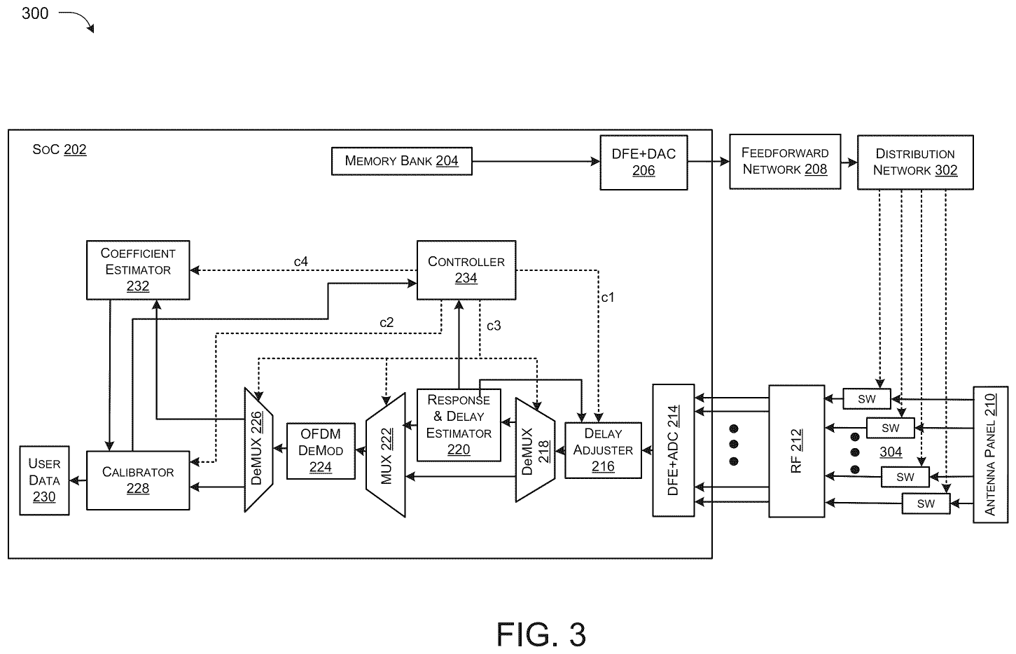

FIG. 3 illustrates an exemplary system architecture (300) for antenna calibration with no calibration port inside an antenna panel (210), in accordance with an embodiment of the present disclosure.

A person skilled in the art may understand that the various modules mentioned in FIG. 3 may be similar to the corresponding modules of FIG. 2 in their functionality and may not be described again for the sake of brevity.

With reference to FIG. 3, a distribution network (302) may contain a series of splitters to equally distribute a signal to each receive chain. In an embodiment, switches (304) may switch between the signal from the antenna panel (210) and the distribution network (302).

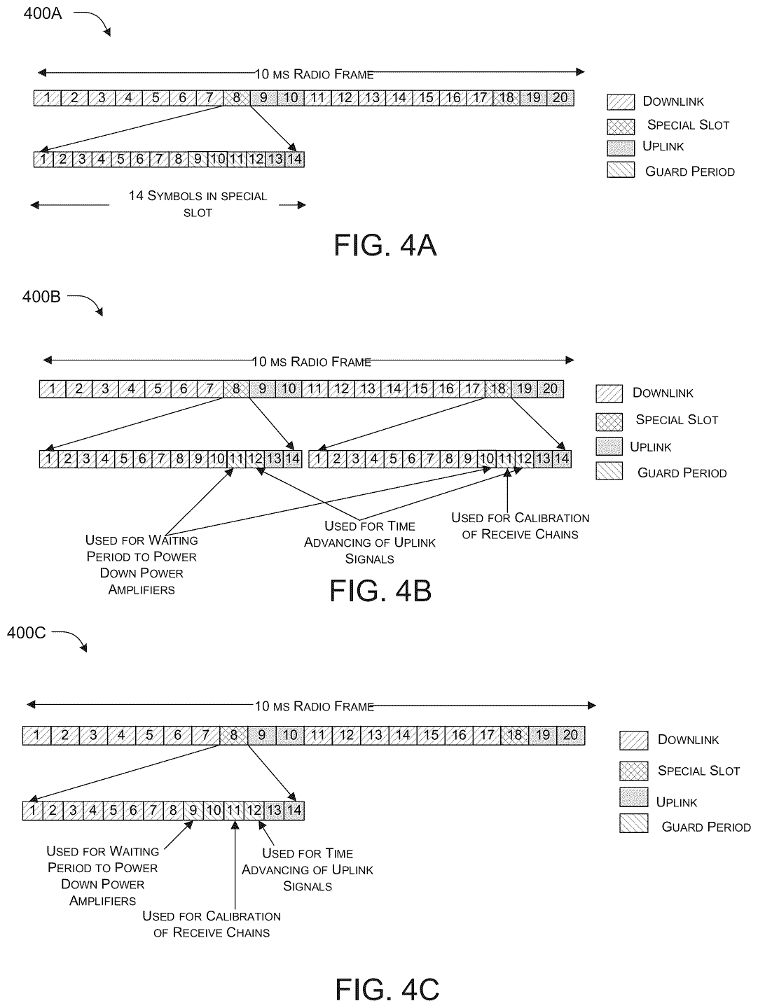

FIG. 4A illustrates an exemplary representation (400A) of a 5G New Radio (NR) Time Division Duplex (TDD) radio frame, in accordance with an embodiment of the present disclosure.

With reference to FIG. 4A, considering the 30 kHz subcarrier spacing, a 10 ms radio frame may include 20 time slots, each having 14 OFDM symbols. The downlink may occupy 14 slots, and the uplink may occupy 4 slots out of 20 slots in normal conditions. The rest of the two slots may be used as special slots. The 14 OFDM symbols in each special slot may be configured as 8 symbols for downlink, 4 symbols for the guard period, and 2 symbols for uplink. To avoid information loss, a MIMO wireless communication device, for example, a base station utilizes the guard period of the special slots to perform the calibration operation during the operating phase.

FIG. 4B illustrates an exemplary representation (400B) for implementing calibration in a special slot with two and three guard periods, in accordance with an embodiment of the present disclosure.

With reference to FIG. 4B, if only two guard periods are present in one special slot, then fine-tuned calibration of the receive chains may not be implemented as the first guard period may be used as a waiting period to power down power amplifiers of transmit chains so that there may be no leakage to the receive chains. In such a scenario, higher layers of the base station may increase the number of guard periods of the next special slot to perform fine-tuned calibration of the receive chains. In another embodiment, if three guard periods are present in one special slot, then fine-tuned calibration of the receive chains may be implemented in the second last guard period.

FIG. 4C illustrates an exemplary representation (400C) for implementing calibration in a special slot with four guard periods, in accordance with an embodiment of the present disclosure.

With reference to FIG. 4C, if four or more guard periods are present in one radio frame, then fine-tuned receive chain calibration may be implemented in the second last guard period of the same special slot.

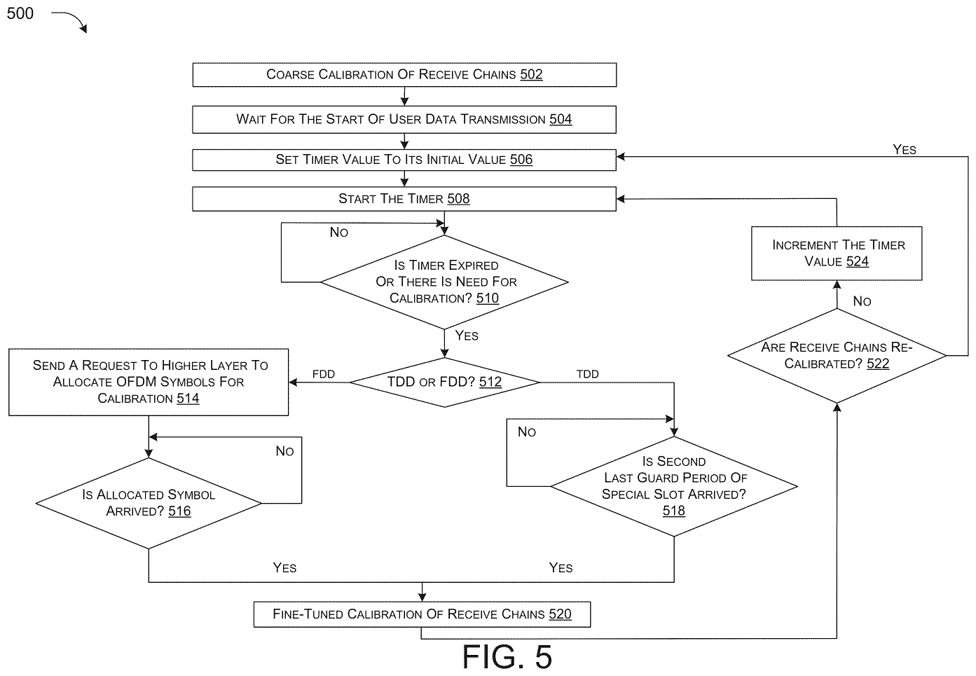

FIG. 5 illustrates a high-level flow chart of an exemplary method (500) for antenna calibration of receive chains, in accordance with an embodiment of the present disclosure. It may be appreciated that the method (500) may be implemented by the MIMO wireless communication device, e.g. the controller (234) or the processor.

The antenna calibration of a 5G NR TDD MIMO wireless communication device, for example, a base station may measure signal characteristics across the receive chains, and determine the differences across the chains, specifically in terms of gain, phase, and timing. Further, the antenna calibration may calibrate the receive signals to mitigate the differences across the receive chains. The calibration may include two phases, namely a start-up phase and an operating phase.

In the start-up phase, the calibration may be implemented during a start-up/booting of the base station. It may be considered as a coarse calibration of the base station as it equalizes the gain, phase, and timing differences across the chains, which may occur due to the system design. In the operating phase, the base station may undergo temperature variations, which may affect the characteristics of the chains. Therefore, the calibration may be required during the operating phase, and thus, it may be considered as a fine-tuned calibration. The temperature variation may become slow once the base station reaches a steady state. Thus, the calibration in the operating phase may not be required frequently.

In an embodiment, the base station may be operated with a TDD radio frame to perform the calibration in a guard period during the operating phase without halting the user data transmission. This may provide leverage to the base station to maintain the spectrum efficiency of the TDD system in real-time. In another embodiment, for Frequency Division Duplex (FDD) base station, a request may be sent to the higher layer to provide the configurable number of vacated OFDM symbols for calibration. The higher layer vacates the requested number of OFDM symbols in one or more FDD radio frames and provides the frame number and OFDM symbol number to the base station (e.g., the controller (234)) to perform calibration during the operating phase.

With reference to FIG. 5, at step 502, a startup phase/coarse calibration of the receive chains may be implemented. At step 504, the method (500) may include waiting for the operating phase to start the user data transmission. At step 506, a value of a timer may be set to its initial value, which may be configurable. At step 508, the timer may be started. In an embodiment, the operating phase/fine-tuned calibration may be implemented every time the timer expires. The operating phase/fine-tuned calibration may also be performed as requested by the higher layers or in an event of a significant change in the temperature, or a fault being identified in a reference chain.

Referring to FIG. 5, at step 510, the method (500) may include determining if the timer has expired or if there is a need for calibration. The need for the calibration of the plurality of receive chains may be based on, without limitation, an expiry of the timer, a request by the one or more higher layers, an event of a change in temperature, and a fault being identified in a given receive chain of the plurality of receive chains. If the timer has not expired and/or there is no need for calibration, the method (500) may include continuing to monitor the timer and/or the need for calibration. At step 512, if the timer has expired or there is the need for calibration, the method (500) may include determining if the base station corresponds to TDD or FDD mode.

At step 514, if the base station corresponds to the FDD mode as determined at step 512, the method (500) may include sending the request to one or more higher layers of the base station to allocate configurable number of vacated OFDM symbols for the calibration. At step 516, the method (500) may include determining if the allocated OFDM symbols have arrived or not.

At step 520, if the allocated OFDM symbols have arrived, the method (500) may include performing the fine-tuned calibration of the receive chains in the allocated OFDM symbols. If the allocated OFDM symbols have not arrived, the method (500) may include continuing to monitor whether the OFDM symbols have arrived or not.

At step 518, if the base station corresponds to the TDD mode, the method (500) may include determining an arrival of a second last guard period of a special time slot. At step 520, the method (500) may include performing the fine-tuned calibration of the receive chains in the second last guard period of the special time slot. If the second last guard period of the special time slot has not arrived, the method (500) may include continuing to monitor the arrival of the special time slot.

At step 522, the method (500) may include determining whether re-calibration of the receive chains is performed. At step 524, if re-calibration of the receive chains is not performed, the value of the timer may be incremented, and the method (500) may proceed to step 508. If the re-calibration of the receive chains is performed, the method (500) may proceed to step 506.

In an embodiment, the calibration periodicity may be periodic and adaptive. In periodic calibration, the timer value may be constant, i.e., the calibration may be repeated after every one or two or any fixed number of TDD radio frames. In adaptive calibration, the timer value may not be fixed and may be updated adaptively.

Adaptive calibration may mitigate the issues of the periodic calibration. Since the temperature variation is expected to be higher during the initial time of the operating phase, the timer value may be incremented by smaller values. After certain cycles, the timer value may be incremented by larger values. For example, the Fibonacci series of 1, 2, 3, 5, 8, 13, 21, 34, 55, 89, 144, 233, 377, 610 (seconds) may be used as the timer value.

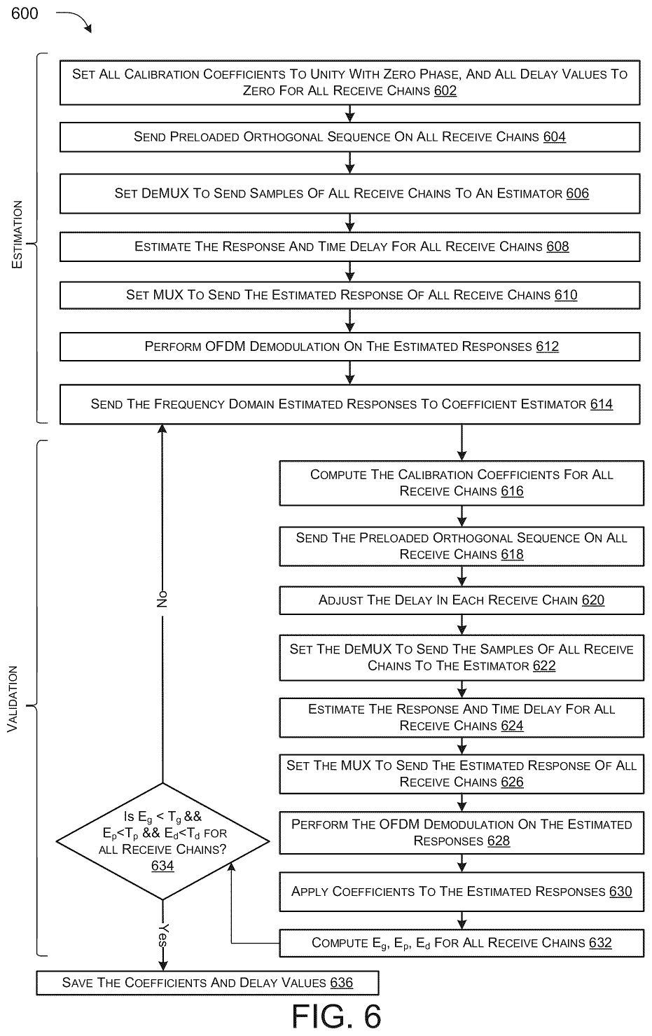

FIG. 6 illustrates a flow chart of an exemplary method (600) for coarse calibration of receive chains in a MIMO wireless communication device, in accordance with an embodiment of the present disclosure.

With reference to FIG. 6, at step 602, the method (600) may include setting all calibration coefficients to unity with zero phase and all delay values to zero in a calibrator (e.g., 228 of FIG. 2) and a delay adjuster (e.g., 216) for all receive chains using control signals (c₂), (c₁), respectively.

At step 604, the method (600) may include sending preloaded orthogonal sequence on all receive chains. The orthogonal sequence is used as a reference to calibrate the receive chains. In one of the embodiments, the orthogonal sequence can be, for example, ZadoffChu sequence or CAZAC signal. In an embodiment, the orthogonal sequence may be generated offline and stored in a memory. In another embodiment, a ZadoffChu sequence generator may be implemented in the SoC (e.g., 202) to generate the sequence in real-time. The ZadoffChu sequence has two key parameters: length of the sequence N_{ZC}, which must be an odd prime number, and root index q=0, 1, 2, . . . , N_{ZC}−1. With these two parameters, it can be defined as:

$${Z}^{q} ( n ) = {e}^{- j 2 π q \frac{n ( n + 1 )}{{N}_{ZC}}}$$

where n=0, 1, 2, . . . , N_{ZC}−1

The length of the ZadoffChu sequence should be a prime number and can be configurable. For example, it can be the largest prime number smaller than the FFT size. Zero padding can match the sequence length to the FFT size.

In an embodiment, the ZadoffChu sequence may undergo DFE and DAC processing before feeding to the feedforward network. This signal may be equally distributed in each receive chain and processed through RF, ADC, and DFE blocks.

At step 606, the method (600) may include setting a first demultiplexer (e.g., 218) using control signal (c₃) to send samples of all receive chains to a response delay and estimator (e.g., 220).

At step 608, the method (600) may include estimating the response and timing delay, i.e., first response and first timing delay, for each receive chain by cross-correlating each receive signal with the ZadoffChu sequence by the response and delay estimator 220.

The periodic cross-correlation W of y with Z is defined as

$$W ( m ) = \frac{1}{\sqrt{{N}_{ZC}}} {\sum }_{n = 0}^{{N}_{ZC} - 1} y ( n ) Z * ( ( n - m ) mod {N}_{ZC} )$$

where “*” is the complex conjugate, and “mod” is the modulus operator.

At step 610, the method (600) may include setting a multiplexer (e.g., 222) using the control signal (c₃) to send the estimated response of all receive chains to an OFDM demodulator (e.g., 224). At step 612, the method (600) may include performing OFDM demodulation on the estimated responses to obtain frequency domain first responses.

At step 614, the method (600) may include sending the frequency domain first responses to a coefficient estimator (e.g., 232). At step 616, the method (600) may include computing calibration coefficients and delay values for each receive chain based on the frequency domain first responses to mitigate relative gain and phase differences with respect to a given receive chain. In an embodiment, the coefficient estimator (232) estimates the calibration coefficients using control signal (c₄) for each receive chain.

At step 618, the method (600) may include sending the preloaded orthogonal sequences on each receive chain. At step 620, the method (600) may include controlling the first timing delay in each receive chain by adjusting a timing of the orthogonal sequences using the delay adjuster (216).

At step 622, the method (600) may include setting the first demultiplexer (218) using the control signal (c₃) to load the received sequences to the response ad delay estimator (220). At step 624, the method (600) may include estimating a second response and a second timing delay for each receive chain by cross-correlating each signal with the orthogonal sequence by the response and delay estimator (220).

At step 626, the method (600) may include setting the multiplexer (222) using control signal (c₃) to send the estimated second responses to the OFDM demodulator (224). At step 628, the method (600) may include performing OFDM demodulation on the estimated second responses to obtain frequency domain second responses.

At step 630, the method (600) may include applying the calibration coefficients on the frequency domain second responses. At step 632, the method includes calculating E_{g}, Eₚ, and E_{d} for each chain with respect to the reference chain and comparing E_{g}, Eₚ, and E_{d} with T_{g}, Tₚ, and T_{d}, respectively. At 634, the method (600) may include determining if E_{g}<T_{g}, Eₚ<Tₚ, and E_{d}<T_{d} are satisfied. If not satisfied, the method (600) may repeat the steps 614 to 632 with different root index of the ZadoffChu sequence. At step 636, if E_{g}<T_{g}, Eₚ<Tₚ, and E_{d}<T_{d} are satisfied, the current coefficients and the delay values may be saved in a database associated with the MIMO wireless communication device, for example, the base station.

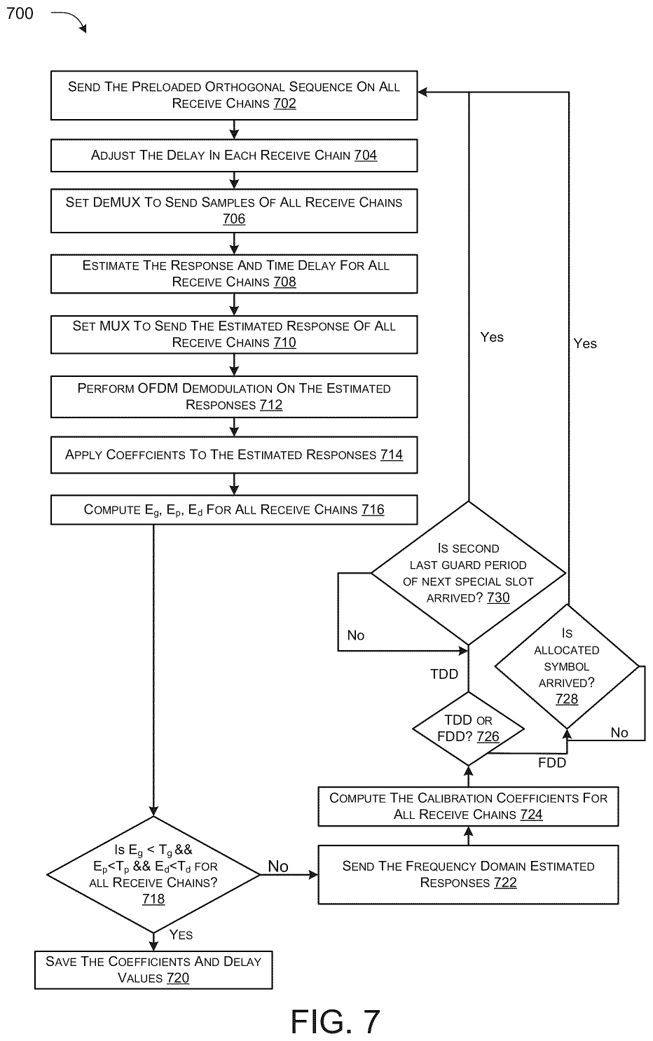

FIG. 7 illustrates a flow chart of an exemplary method (600) for implementing fine-tuned calibration of receive chains during an operating phase of a MIMO wireless communication device, in accordance with an embodiment of the present disclosure.

With respect to FIG. 7, at step 702, the method (700) may include sending preloaded orthogonal sequences to all receive chains. At step 704, the method (700) may include adjusting delay of the received sequences using the delay adjuster (216).

At step 706, the method (700) may include setting a first demultiplexer (218) using control signal (c₃) to load the received sequences to the response and delay estimator (220). At step 708, the method (700) may include estimating a first response and a first timing delay for each receive chain by cross-correlating each receive signal with the orthogonal sequence by the response and delay adjuster (220).

At step 710, the method (700) may include setting a multiplexer (222) using control signal (c₃) to load the estimated first responses to an OFDM demodulator (224). At step 712, the method (700) may include performing OFDM demodulation on the estimated first responses to obtain frequency domain first responses.

At step 714, the method (700) may include applying calibration coefficients on the frequency domain first responses. At step 716, the method (700) may include calculating E_{g}, Eₚ, and E_{d} for each chain with respect to a reference chain. At step 718, the method (700) may include comparing E_{g}, Eₚ, and E_{d} with T_{g}, Tₚ, and T_{d}, respectively. If E_{g}<T_{g} and Eₚ<Tₚ and E_{d}<T_{d} are satisfied, the method (700), at step 720, includes saving the current calibration coefficients and delay values in a database associated with a MIMO wireless communication device, for example, a base station. If E_{g}<T_{g} and Eₚ<Tₚ and E_{d}<T_{d} are not satisfied, the method (700), at step 722 may include sending the frequency domain first responses to the coefficient estimator (232).

At step 724, the method (700) may include estimating updated calibration coefficients using control signal (c₄) for each receive chain in order to mitigate the relative gain and phase differences with respect to the reference chain.

At step 726, the method (700) may include determining if the base station corresponds to TDD or FDD mode. At step 728, if the base station corresponds to the FDD mode, the method (700) may include determining the arrival of the specific OFDM symbol allocated by the higher layer in the base station for performing the fine-tuned calibration of the receive chains. If the specific OFDM symbol has arrived, the new estimated calibration coefficients may be loaded into the calibrator (228) using the control signal (c₂) and the delay values into the delay adjuster (216) using the control signal (c₁), and the steps 702 to 726 may be repeated. If the specific OFDM symbol has not arrived, the method (700) may continue to monitor the arrival of the specific OFDM symbol.

At step 730, if the base station corresponds to the TDD mode, the method (700) may include determining the arrival of the second last guard period of the next special slot to validate the new estimated coefficients or updated coefficients, as shown in FIG. 9. FIG. 9 depicts an example representation (900) of fine-tuned calibration in two special slots. If the second last guard period of the next special slot has arrived, the new estimated calibration coefficients may be loaded into the calibrator (228) using the control signal (c₂) and the delay values into the delay adjuster (216) using the control signal (c₁), and the steps 702 to 726 may be repeated. If the second last guard period of the next special slot has not arrived, the method (700) may continue to monitor the arrival of the second last guard period of the next special slot.

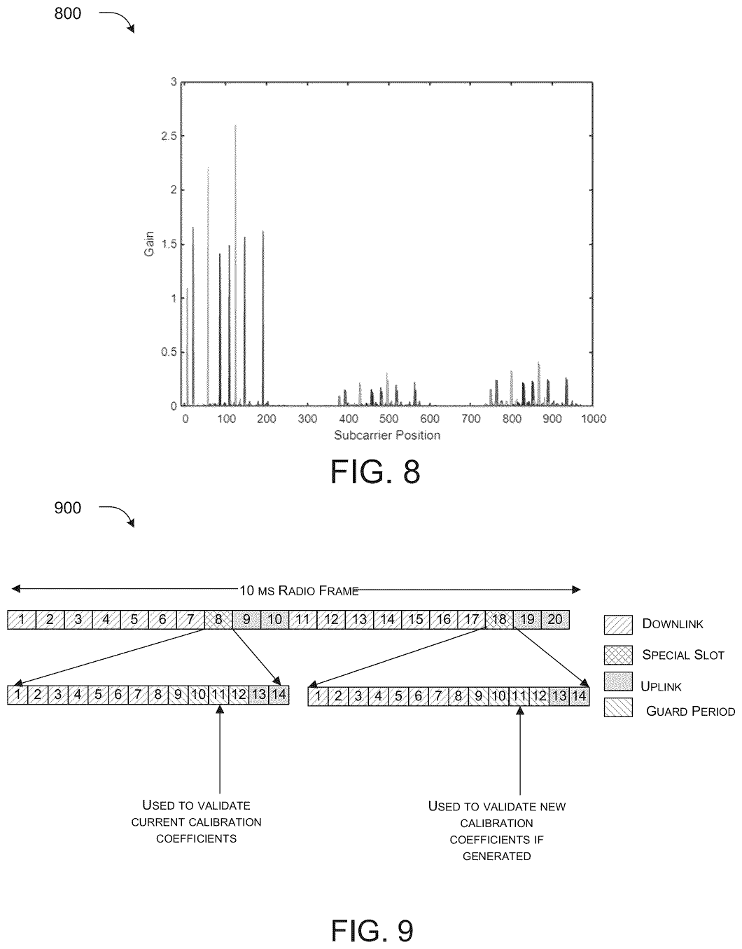

FIG. 8 illustrates an example gain plot (800) of estimated value of receive chain responses before calibration.

In particular, FIG. 8 shows the gain plot (800) of the time domain estimated response of 8 receive chains. It may be observed that 8 peaks present in the gain plot (800) represent the gain response of the 8 receive chains. Ideally, these responses should appear in 1^{st} position. However, they deviate from their expected positions and appear at 144^{th}, 18^{th}, 54^{th}, 107^{th}, 4^{th}, 122^{nd}, 84^{th}, and 189^{th} subcarrier positions. These positions represent the timing delay (d) of each receive chain.

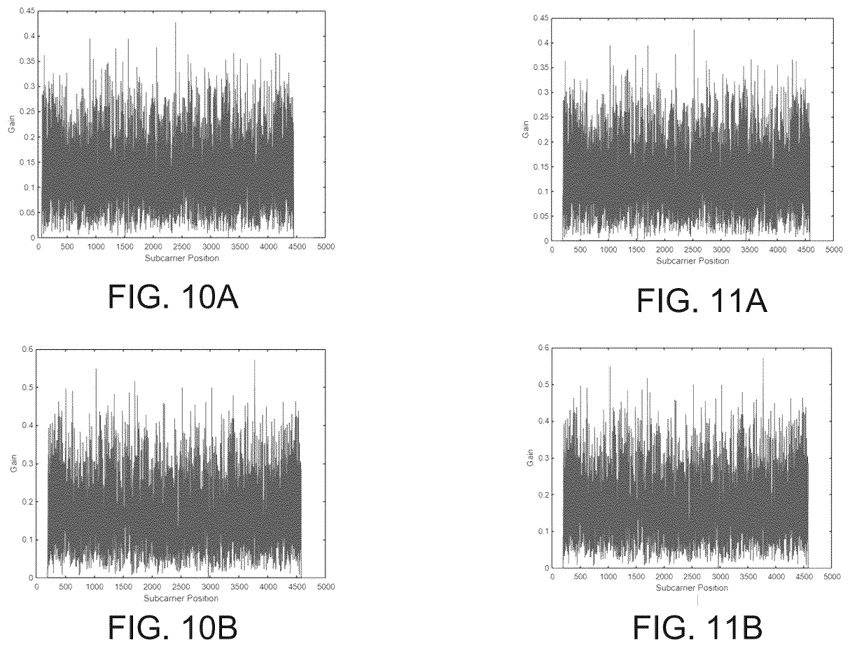

FIGS. 10A and 10B illustrate exemplary representations of a gain plot of a time domain signal of third receive chain and eighth receive chain without calibration, respectively.

Referring to FIGS. 10A and 10B, it may be observed that the signals are delayed by different time values as well as their gain responses are also not identical in the absence of antenna calibration. A similar mismatch can also be observed with the remaining chains.

FIGS. 11A and 11B illustrate exemplary representations of a gain plot of time domain signals of third receive chain and eighth receive chain with antenna calibration, in accordance with an embodiment of the present disclosure.

Referring to FIGS. 11A and 11B, it may be observed that the responses of both transceivers are delayed with the same time value in the presence of antenna calibration.

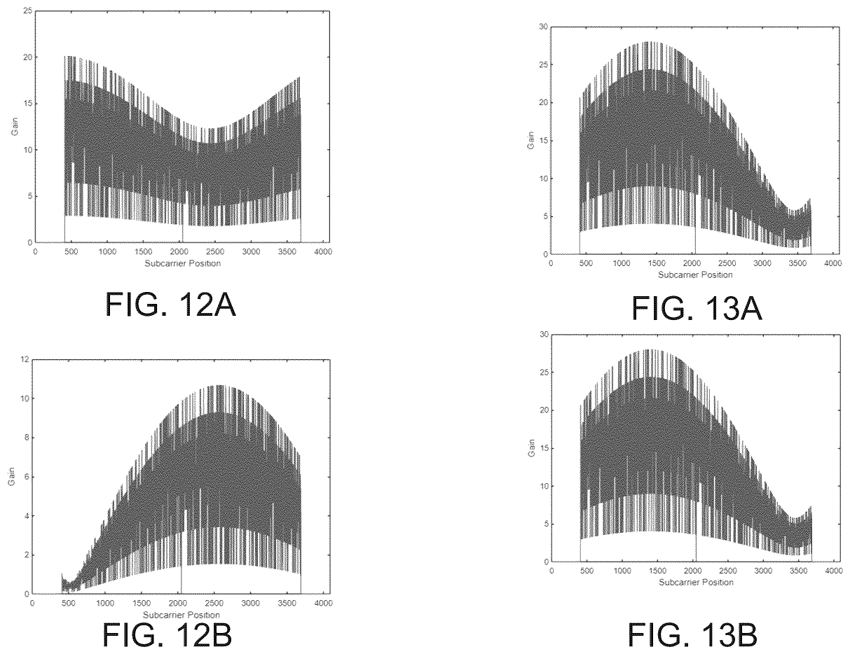

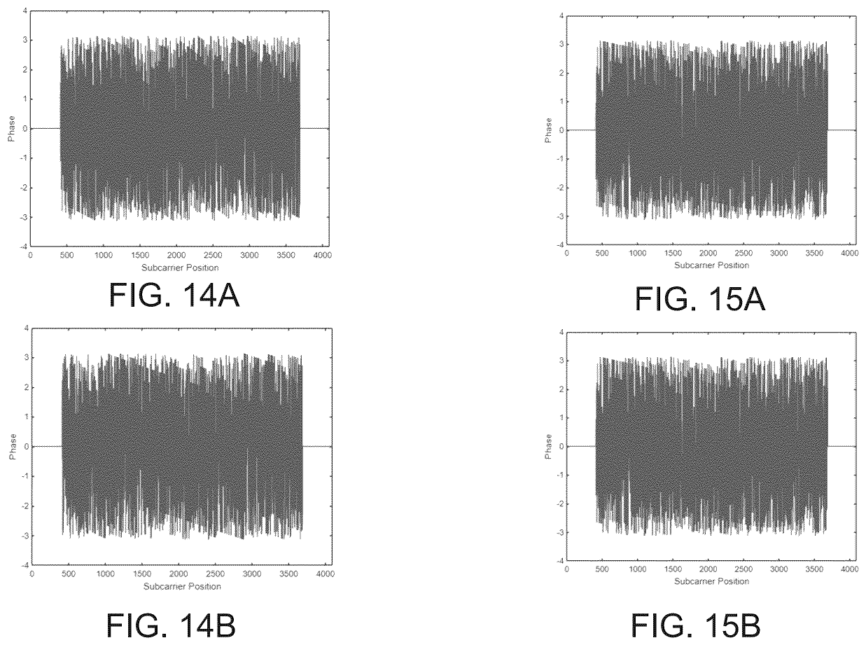

FIGS. 12A and 12B illustrate exemplary representations of a gain plot of frequency domain signals of third receive chain and eighth receive chain without antenna calibration. FIGS. 14A and 14B illustrate exemplary representations of a phase plot of frequency domain signals of third receive chain and eighth receive chain without antenna calibration.

Referring to FIGS. 12A, 12B, 14A, and 14B, it may be observed that in the absence of antenna calibration, the responses of both transceivers are not identical, and a similar mismatch can also be observed with the remaining chains.

FIGS. 13A and 13B illustrate exemplary representations of a gain plot of frequency domain signals of third receive chain and eighth receive chain with antenna calibration, in accordance with an embodiment of the present disclosure. FIGS. 15A and 15B illustrate exemplary representations of a phase plot of frequency domain signals of third receive chain and eighth receive chain with antenna calibration, in accordance with an embodiment of the present disclosure.

Referring to FIGS. 13A, 13B, 15A, and 15B, it may be observed that the gain and phase of the third and eighth transceivers become equivalent, and similar behavior can also be seen in the remaining chains.

Therefore, it may be concluded that the system and method for the antenna calibration of receive chains of the 5G NR TDD MIMO wireless communication device may be used to mitigate the gain, phase, and timing differences across the receive chains.

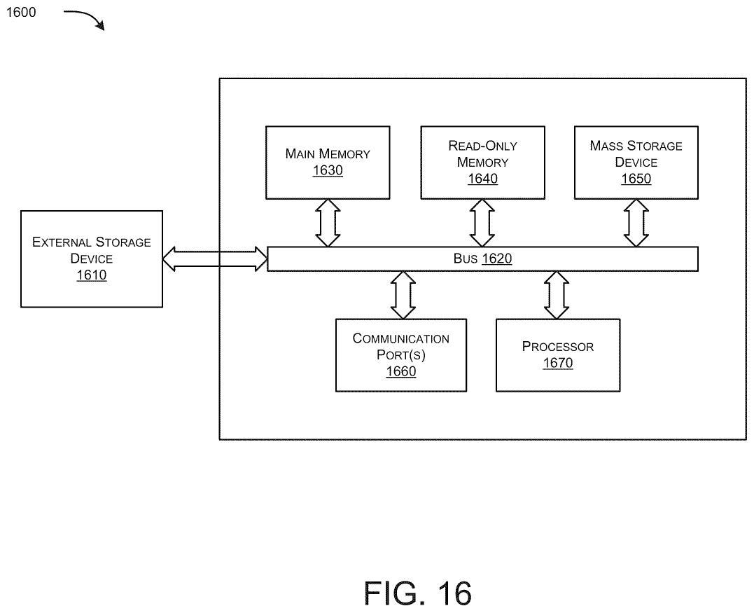

FIG. 16 illustrates an exemplary computer system (1600) in which or with which embodiments of the present disclosure may be implemented.

The blocks of the flow diagrams shown in FIGS. 5, 6, and 7 have been arranged in a generally sequential manner for ease of explanation; however, it is to be understood that this arrangement is merely exemplary, and it should be recognized that the processing associated with methods (500, 600, 700) may occur in a different order (for example, where at least some of the processing associated with the blocks is performed in parallel and/or in an event-driven manner). Further, it may be appreciated that the steps shown in FIGS. 5, 6, and 7 are merely illustrative. Other suitable steps may be used for the same, if desired. Moreover, the steps of the method (500, 600, 700) may be performed in any order and may include additional steps.

The methods and techniques described herein may be implemented in digital electronic circuitry, field programmable gate array (FPGA), or with a programmable processor (for example, a special-purpose processor or a general-purpose processor such as a computer) firmware, software, or in combinations of them. Apparatus embodying these techniques may include appropriate input and output devices, FPGA, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system, explained in detail with reference to FIG. 16, including at least one programmable processor coupled to receive data and instructions from, and to transmit data and instructions to, a data storage system, at least one input device, and at least one output device. Generally, a processor will receive instructions and data from a read-only memory and/or a random-access memory. Storage devices suitable for tangibly embodying computer program instructions and data include all forms of non-volatile memory, including by way of example semiconductor memory devices, such as erasable programmable read-only memory (EPROM), and flash memory devices; magnetic disks such as internal hard disks and removable disks; and magneto-optical disks. Any of the foregoing may be supplemented by, or incorporated in, specially designed application-specific integrated circuits (ASICs).

In particular, FIG. 16 illustrates an exemplary computer system (1600) in which or with which embodiments of the present disclosure may be utilized. The computer system (1600) may be implemented as or within the MIMO wireless communication device, for example the base station described in accordance with embodiments of the present disclosure.

As depicted in FIG. 16, the computer system (1600) may include an external storage device (1610), a bus (1620), a main memory (1630), a read-only memory (1640), a mass storage device (1650), communication port(s) (1660), and a processor (1670). A person skilled in the art will appreciate that the computer system (1600) may include more than one processor (1670) and communication ports (1660). The processor (1670) may include various modules associated with embodiments of the present disclosure. The communication port(s) (1660) may be any of an RS-232 port for use with a modem-based dialup connection, a 10/100 Ethernet port, a Gigabit or 10 Gigabit port using copper or fiber, a serial port, a parallel port, or other existing or future ports. The communication port(s) (1660) may be chosen depending on a network, such a Local Area Network (LAN), Wide Area Network (WAN), or any network to which the computer system (1600) connects.

In an embodiment, the main memory (1630) may be Random Access Memory (RAM), or any other dynamic storage device commonly known in the art. The read-only memory (1640) may be any static storage device(s) e.g., but not limited to, a Programmable Read Only Memory (PROM) chips for storing static information e.g., start-up or basic input output system (BIOS) instructions for the processor (1670). The mass storage device (1650) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (1620) communicatively couples the processor (1670) with the other memory, storage, and communication blocks. The bus (1620) may be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects the processor (1670) to the computer system (1600).

In another embodiment, operator and administrative interfaces, e.g., a display, keyboard, and a cursor control device, may also be coupled to the bus (1620) to support direct operator interaction with the computer system (1600). Other operator and administrative interfaces may be provided through network connections connected through the communication port(s) (1660). Components described above are meant only to exemplify various possibilities. In no way should the aforementioned exemplary computer system (1600) limit the scope of the present disclosure.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Present Disclosure

The present disclosure facilitates calibration of Radio Frequency (RF) paths at a start-up phase and during an operating phase of a fifth-generation (5G) multiple-input-multiple-output (MIMO) wireless communication device adaptively without impacting user data transmission.

The present disclosure facilitates calibration of RF paths during run-time of a communication apparatus, i.e., calibration of RF receive path in between data transmission without affecting a data transmission rate.

The present disclosure enables handling of variation in temperature and processing of delay between multiple RF transmission paths.

The present disclosure facilitates adaptive calibration of RF receive chains in a Multiple-Input Multiple-Output (MIMO) communication apparatus which also utilizes resources optimally and effectively.

1. A method (600) for calibration of receive chains in a start phase of a multiple-input-multiple-output (MIMO) wireless communication device, comprising:
setting (602), by a controller (234) associated with the MIMO wireless communication device, delay values to zero and calibration coefficients to unity with zero phase for each of a plurality of receive chains;
sending (604), by the controller (234), orthogonal sequences on each of the plurality of receive chains;
estimating (608), by the controller (234), a first response and a first time delay for each of the plurality of receive chains by cross-correlating each receive signal from each of the plurality of receive chains with an orthogonal sequence;
performing (612), by the controller (234), Orthogonal Frequency-Division Multiplexing (OFDM) demodulation on the estimated first responses to obtain frequency domain first responses; and
computing (616), by the controller (234), calibration coefficients and delay values for each of the plurality of receive chains based on the frequency domain first responses to mitigate relative gain and phase differences with respect to a given receive chain.

2. The method (600) as claimed in claim 1, comprising:
sending (618), by the controller (234), the orthogonal sequences on each of the plurality of receive chains;
controlling (620), by the controller (234), the first time delay in each of the plurality of receive chains by adjusting a timing of the orthogonal sequences;
estimating (614), by the controller (234), a second response and a second time delay for each of the plurality of receive chains;
performing (628), by the controller (234), the OFDM demodulation on the estimated second responses to obtain frequency domain second responses; and
applying (630), by the controller (234), the computed calibration coefficients on the frequency domain second responses.

3. The method (600) as claimed in claim 2, comprising:
computing (632), by the controller (234), a gain difference, a phase difference, and a timing delay difference of each of the plurality of receive chains with respect to the given receive chain; and
comparing (634), by the controller (234), the gain difference, the phase difference, and the timing delay difference of each of the plurality of receive chains with a gain error threshold, a phase error threshold, and a delay error threshold, respectively.

4. The method (600) as claimed in claim 3, wherein responsive to at least one of the gain difference, the phase difference, and the timing delay difference of each of the plurality of receive chains being less than the gain error threshold, the phase error threshold, and the delay error threshold, respectively, the method (600) comprises storing (636), by the controller (234), the computed calibration coefficients and the computed delay values in a database associated with the MIMO wireless communication device to perform calibration of the plurality of receive chains.

5. The method (600) as claimed in claim 3, wherein responsive to at least one of the gain difference, the phase difference, and the timing delay difference of each of the plurality of receive chains being greater than the gain error threshold, the phase error threshold, and the delay error threshold, respectively, the method (600) comprises computing, by the controller, updated calibration coefficients and/or updated delay values for each of the plurality of receive chains based on the frequency domain first responses to mitigate the gain difference, the phase difference, or the timing delay difference with respect to the given receive chain.

6. A method for calibration of receive chains in a multiple-input-multiple-output (MIMO) wireless communication device, comprising:
determining, by a controller (234) associated with the MIMO wireless communication device, that user data transmission is initiated in an operating phase of the MIMO wireless communication device;
determining, by the controller (234), a need for calibration of a plurality of receive chains in the MIMO wireless communication device;
in response to the determination, detecting, by the controller (234), an arrival of at least one of: a second last guard period of a special time slot in a Time-Division Duplex (TDD) radio frame, or an Orthogonal Frequency-Division Multiplexing (OFDM) symbol allocated by one or more higher layers in a Frequency-Division Duplex (FDD) radio frame; and
performing, by the controller (234), fine-tuned calibration of each of the plurality of receive chains based on the detection.

7. The method as claimed in claim 6, wherein determining, by the controller (234), the need for the calibration of the plurality of receive chains is based on at least one of: an expiry of a timer, a request by the one or more higher layers, an event of a change in temperature, and a fault being identified in a given receive chain of the plurality of receive chains.

8. The method as claimed in claim 6, wherein performing, by the controller (234), the fine-tuned calibration of each of the plurality of receive chains comprises:
sending, by the controller (234), orthogonal sequences on each of the plurality of receive chains;
controlling, by the controller (234), a delay in each of the plurality of receive chains by adjusting a timing of the orthogonal sequences;
estimating, by the controller (234), a response and a time delay for each of the plurality of receive chains by cross-correlating each receive signal from each of the plurality of receive chains with an orthogonal sequence;
performing, by the controller (234), OFDM demodulation on the estimated responses to obtain frequency domain responses; and
applying, by the controller (234), calibration coefficients on the frequency domain responses, wherein the calibration coefficients are computed during a start phase of the MIMO wireless communication device or during earlier stages of the operating phase.

9. The method as claimed in claim 8, comprising:
computing, by the controller (234), a gain difference, a phase difference, and a timing delay difference of each of the plurality of receive chains with respect to a given receive chain; and
comparing, by the controller (234), the gain difference, the phase difference, and the timing delay difference of each of the plurality of receive chains with a gain error threshold, a phase error threshold, and a delay error threshold, respectively.

10. The method as claimed in claim 9, wherein responsive to at least one of the gain difference, the phase difference, and the timing delay difference of each of the plurality of receive chains being less than the gain error threshold, the phase error threshold, and the delay error threshold, respectively, the method comprises storing, by the controller (234), the calibration coefficients in a database associated with the MIMO wireless communication device to perform the fine-tuned calibration of each of the plurality of receive chains.

11. The method as claimed in claim 9, wherein responsive to at least one of the gain difference, the phase difference, and the timing delay difference of each of the plurality of receive chains being greater than the gain error threshold, the phase error threshold, and the delay error threshold, respectively, the method comprises:
computing, by the controller (234), updated calibration coefficients for each of the plurality of receive chains based on the frequency domain responses;
detecting, by the controller (234), an arrival of at least one of: a second last guard period of a consecutive special time slot in the TDD radio frame, or another OFDM symbol allocated by the one or more higher layers in the FDD radio frame; and
performing, by the controller (234), the fine-tuned calibration of each of the plurality of receive chains based on the detection.

12. The method as claimed in claim 7, wherein the fine-tuned calibration comprises at least an adaptive calibration, and wherein for the adaptive calibration, the method comprises adaptively controlling, by the controller (234), a value of the timer for performing the fine-tuned calibration of the plurality of receive chains.

13. A multiple-input-multiple-output (MIMO) wireless communication device for calibration of receive chains in an operating phase, comprising:
a controller (234) associated with a processor (202); and
a memory operatively coupled to the processor (202), wherein the memory comprises processor-executable instructions which, when executed by the processor (202), cause the controller (234) to:
determine that user data transmission is initiated in the operating phase of the MIMO wireless communication device;
determine a need for calibration of a plurality of receive chains in the MIMO wireless communication device;
in response to the determination, detect an arrival of at least one of: a second last guard period of a special time slot in a Time-Division Duplex (TDD) radio frame, or an Orthogonal Frequency-Division Multiplexing (OFDM) symbol allocated by one or more higher layers in a Frequency-Division Duplex (FDD) radio frame; and
perform fine-tuned calibration of each of the plurality of receive chains based on the detection.

14. The MIMO wireless communication device as claimed in claim 13, wherein to perform the fine-tuned calibration of each of the plurality of receive chains, the memory comprises processor-executable instructions which, when executed by the processor (202), cause the controller (234) to:
send orthogonal sequences on each of the plurality of receive chains;
control a delay in each of the plurality of receive chains by adjusting a timing of the orthogonal sequences;
estimate a response and a time delay for each of the plurality of receive chains by cross-correlating each receive signal from each of the plurality of receive chains with an orthogonal sequence;
perform Orthogonal Frequency-Division Multiplexing (OFDM) demodulation on the estimated responses to obtain frequency domain responses; and
applying, by the controller, calibration coefficients on the frequency domain responses, wherein the calibration coefficients are computed during a start phase of the MIMO wireless communication device or during earlier stages of the operating phase.
